(19) United States
(12) Patent Application Publication
(10) Pub. No.: US 2008/0129777 A1
(43) Pub. Date: Jun. 5, 2008

(54) WASTE LIQUID COLLECTING MECHANISM AND LIQUID EJECTING DEVICE

(75) Inventor: Eiichiro WATANABE, Matsumoto-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 11/950,210

(22) Filed: Dec. 4, 2007

(30) Foreign Application Priority Data
Dec. 5, 2006 (JP) 2006-328344

(51) Int. Cl. B41J 2/165

(52) U.S. Cl. 347/36

(57) ABSTRACT

A waste liquid collecting mechanism for collecting waste liquid ejected from the liquid ejecting head of a liquid ejecting device, the mechanism comprising a reception case partitioned into a plurality of waste liquid storage parts, wherein a waste liquid receiving part capable of storing a predetermined amount of waste liquid is formed inside a surrounding wall disposed adjacent to the waste liquid storage parts, wherein any waste liquid introduced into the waste liquid receiving part that exceed the predetermined amount of waste liquid stored in the waste liquid receiving part is distributed into the waste liquid storage parts by overflowing the surrounding wall.

### BACKGROUND OF THE INVENTION

The entire disclosure of Japanese Patent Application No. 2006-328344, filed Dec. 5, 2006 is expressly incorporated herein by reference.

1. Technical Field

The present invention relates to a liquid ejecting device. More particularly, the present invention relates to a waste liquid collecting mechanism for a liquid ejecting device.

2. Related Art

Liquid ejecting devices eject liquid from a plurality of nozzles formed on liquid ejecting heads. An example of a commonly used liquid ejecting device is an ink jet printer (hereinafter, hereinafter referred to as a printer). Generally, in these printers, a maintenance unit is used for preventing and repairing any clogging generated by thickened ink inside the nozzles.

In each maintenance unit a cap is used to cover the surface of the nozzle, so that during a non-printing periods, the liquid ejecting head is sealed by the cap. Typically, before starting a printing operation, a cleaning operation is performed in which ink inside the liquid ejecting head is ejected from the nozzles, reducing the pressure inside the sealed cap. In other instances, when the liquid ejecting head is not sealed by the cap, flushing operations are performed wherein ink is ejected from the nozzles in order to refresh the ink in the nozzles, thereby preventing the clogging of the nozzles.

The waste liquid discharged from the liquid ejecting head during the cleaning operations or other processes is collected so as not to contaminate the inside of the printer and is stored in a waste container. In a printer having a waste liquid collecting mechanism for collecting and storing the waste liquid as described above, the waste liquid often leaks when the printer is tilted or moved.

In response to this problem, a waste collecting mechanism has been described, wherein a plurality of partitioned storage chambers are formed on the inside of the container using partition plates. Waste liquid is collected in the waste mechanism container using a waste ink flow passage, wherein the waste liquid is distributed and stored in each storage chamber by a distribution member. In one example of such a mechanism is described in Japanese Patent Application JP-A-8-318630, wherein the waste liquid is distributed to four storage chambers by using a distribution member having an upper end connected to an end of the waste ink flow passage and a groove including a plurality of lines which radially extend from the upper end of the distribution member at a predetermined inclination. By distributing and storing the waste liquid in the plurality of storage chambers, the level of the waste liquid is low when the printer is tilted, thereby suppressing the leakage of the waste liquid.

One disadvantage of the of the waste liquid collecting mechanism of JP-A-8-318630, however, is that the container or distribution member where the waste ink flow passage is formed has a complicated shape, and making the configuration of the device complicated.

### BRIEF SUMMARY OF THE INVENTION

An advantage of some aspects of the invention is that it provides a waste liquid collecting mechanism for a liquid ejecting device that is capable of suppressing the leakage of waste liquid using a simple configuration.

A first aspect of the invention is a waste liquid collecting mechanism for collecting the liquid ejected from a liquid ejecting head of a liquid ejecting device. The waste liquid collecting mechanism includes a reception case partitioned into a plurality of waste liquid storage parts. Inside the reception case, a waste liquid receiving part capable of storing a predetermined amount of waste liquid is formed with a surrounding wall that is adjacent to and serves as a boundary to the waste liquid storage parts, wherein any waste liquid introduced into the waste liquid receiving part that exceeds the predetermined amount of waste liquid stored in the waste liquid receiving part flows over the surrounding wall and is distributed to the waste liquid storage parts.

A second aspect of the invention is a liquid ejecting device including a liquid ejecting head for ejecting liquid, and the above-described waste liquid collecting mechanism capable of collecting waste liquid discharged from the liquid ejecting head.

### BRIEF DESCRIPTION OF THE DRAWINGS

The invention will be described with reference to the accompanying drawings, wherein like numbers reference like elements.

FIG. 1 is a perspective view of an ink jet printer according to an embodiment of the present invention;

FIG. 2 is a schematic section view of an ink jet printer according to an embodiment of the invention;

FIG. 3 is a schematic perspective view of a reception case according to a first embodiment of the invention;

FIG. 4 is an exploded perspective view of an absorber according to the first embodiment of the invention;

FIG. 5 is a schematic perspective view of a waste liquid collecting mechanism according to the first embodiment of the invention;

FIG. 6 is a partial section view of the waste liquid collecting mechanism according to the first embodiment of the invention;

FIG. 7A is a schematic plan view of a waste liquid collecting mechanism according to a second embodiment of the invention;

FIG. 7B is a section view of FIG. 7A taken along line A-A of FIG. 7A;

FIG. 8A is a schematic plan view of a waste liquid collecting mechanism according to a third embodiment of the invention; and

FIG. 8B is a section view of FIG. 8A taken along line A-A of FIG. 8A.

### DESCRIPTION OF EXEMPLARY EMBODIMENTS

### First Embodiment

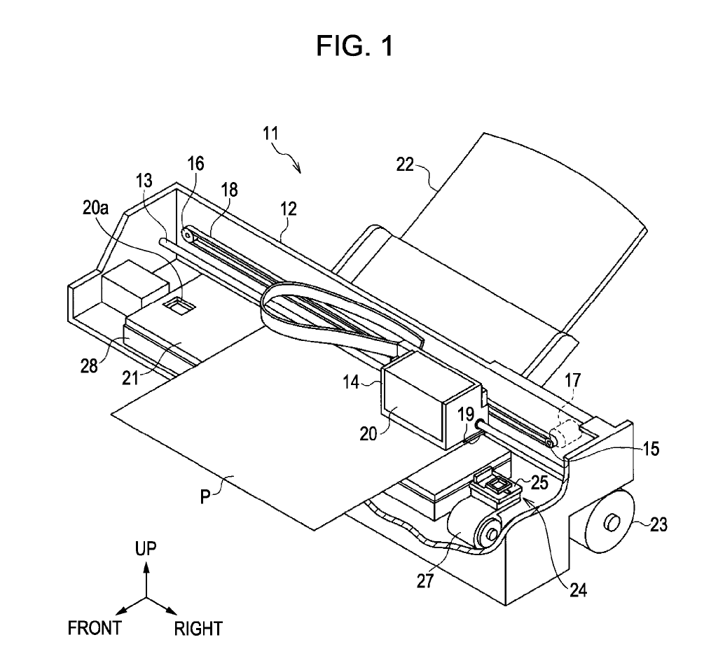

Hereinafter, an ink jet printer (hereinafter, abbreviated as a printer) according to a first embodiment of the present invention will be described with reference to FIGS. 1 to 6.

As shown in FIG. 1, a printer 11, acting as a liquid ejecting device according to this embodiment has a main body case 12 with approximately a rectangular box shape. Between right and left side walls of the main body case 12, a guide shaft 13 is installed along the length of the main body case 12, forming a main scanning direction. A carriage 14 is inserted into and supported by the guide shaft 13 in order to move in the main scanning direction.

A driving pulley 15 and a driven pulley 16 are supported so as to rotate around both ends of the guide shaft 13 on the rear side inside the main body case 12. A carriage motor 17 is connected to the drive pulley 15, and a timing belt 18 having an endless shape is fitted between the pulleys 15 and 16.

One portion of the carriage 14 on the rear side is fixed to a portion of the timing belt 18. Accordingly, the carriage 14 can be driven by the carriage motor 17 to reciprocate along the guide shaft 13 in the main scanning direction.

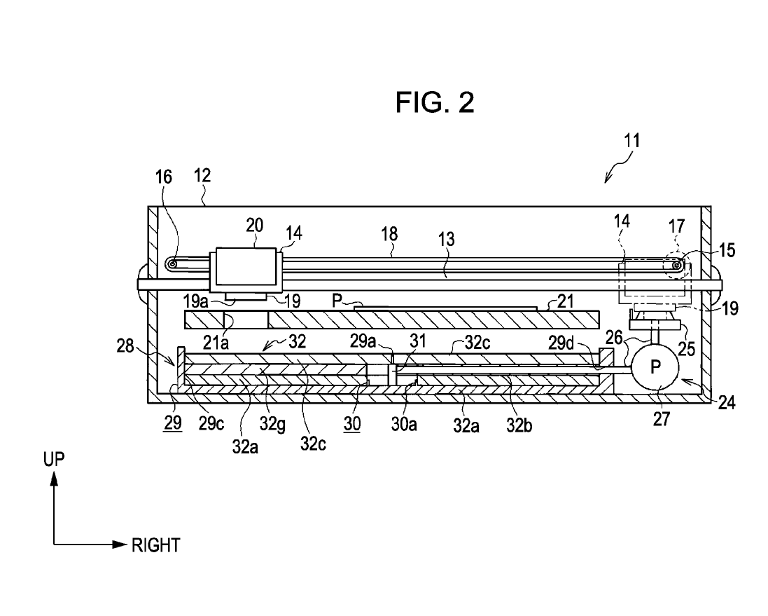

A recording head 19 that is used as a liquid ejecting head is disposed on the bottom side of the carriage 14. A bottom side of the recording head 19 forms a nozzle forming surface 19a (see FIG. 2) wherein a plurality of nozzle lines (not shown) ejecting ink as liquid are disposed.

To the top side of the carriage 14, an ink cartridge 20 is detachably attached in order to supply ink to the recording head 19. Inside the recording head 19, ink supply passages (not shown) are formed for supplying ink stored inside the ink cartridge 20 to the nozzles.

A platen 21 for supporting recording paper P is disposed in a position facing the nozzle forming surface 19a inside the main body case 12. In addition, a feed tray 22 for feeding the recording paper P is disposed on the rear side of the main body case 12, and a paper transporting motor 23 is disposed in a lower right side of the main body case 12. When the paper transporting motor 23 is driven, a paper transporting roller not shown in the figure is rotated, and the recording paper P set on the feed tray 22 is transported on the platen 21 in a sub scanning direction that is perpendicular to the main scanning direction. A printing process for the recording paper P is performed by alternately repeating an ink ejecting operation on the printing paper P, by ejecting ink from the nozzle forming surface 19a of the recording head 19 while reciprocating the carriage 14 in the main scanning direction and transporting the recording paper P a predetermined transport distance in the sub scanning direction.

In FIGS. 1 and 2, a right end portion is set as a home position for the carriage 14, which serves as a standby position when a printing process is not being performed. When the carriage 14 is disposed in the home position, a maintenance unit 24 situated below the carriage 14 performs a maintenance operation, such as a cleaning operation, on the recording head 19.

As shown in FIG. 2, the maintenance unit 24 has a cap 25 for preventing the ink inside the nozzle of the recording head 19 from drying, a waste liquid tube 26 whose upstream end is opened toward a inner bottom surface of the cap 25 for collecting waste liquid, and a suction pump 27 for generating a negative pressure inside the cap 25.

As represented by the dotted line shown in FIG. 2, when the carriage 14 is in the home position, the recording head 19 is positioned directly above the cap 25, the cap is moved upward by a drive unit (not shown) so as to tightly contact the nozzle forming surface 19a of the recording head 19, in order to seal the nozzle forming surface 19a. Then, when the nozzle forming surface 19a of the recording head 19 is sealed by the cap 25, a negative pressure is generated inside the cap 25 by the suction pump 27, and a cleaning operation for forcedly sucking and discharging ink inside the ink supply passage and the nozzle is performed.

In an end portion (shown as the left end in FIGS. 1 and 2) opposite the home position of the platen 21, a hole 21a is formed through the platen 21. A flushing position (represented as a solid line in FIG. 2) of the carriage 14, is designated as the position wherein the recording head 19 is disposed so as to vertically face the through hole 21a. When the recording head 19 is not sealed by the cap 25, the carriage 14 is moved to the flushing position and ink is ejected regardless of the printing operation, and a flushing operation for discharging ink inside the nozzle is performed.

Below the platen 21, a waste liquid collecting mechanism 28 is disposed for collecting waste liquid discharged from the recording head 19. The ink (waste liquid) discharged from the recording head 19 disposed in the flushing position, is transferred to the waste liquid collecting mechanism 28 through the through hole 21a. In addition, the ink (waste liquid) sucked and discharged from the recording head 19 by the suction pump 27 is, as shown in FIG. 2, collected inside the waste liquid collecting mechanism 28 through the waste liquid tube 26 connected to the cap 25 and the suction pump 27.

Next, the configuration of the waste liquid collecting mechanism 28 will be described in detail.

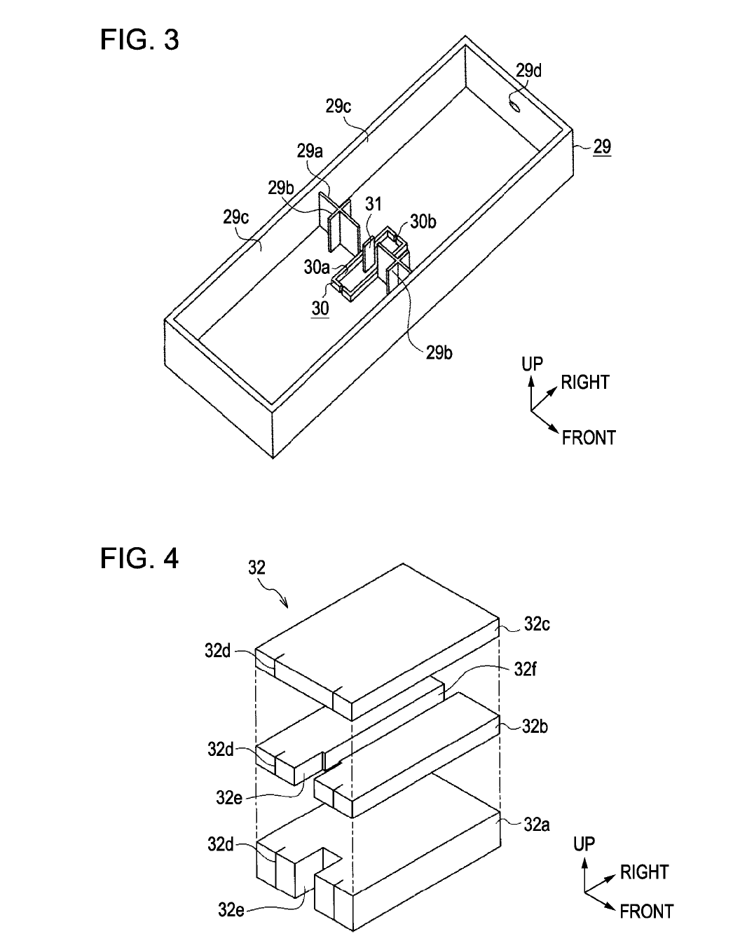

As shown in FIGS. 2 and 3, the waste liquid collecting mechanism 28 has an approximately rectangular box-shaped reception case 29, the top side of which is opened. The inside of the reception case 29 is partitioned into two spaces by a partition plate 29a disposed in approximately the center position in the lengthwise direction. As shown in FIG. 3, two support plates 29b are disposed to intersect the partition plate 29a.

In approximately the middle of the inner bottom surface of the reception case 29, a surrounding wall 30 having a rectangular shape is formed, and a waste liquid receiving part 30a using the surrounding wall 30 as a side wall is formed. In other words, the waste liquid receiving part 30a, which can store a predetermined amount of waste liquid, is surrounded by the surrounding wall 30.

A portion of the partition plate 29a corresponding to the inside of the waste liquid receiving part 30a and an area above the waste liquid receiving part 30a is removed. The inside reception case 29, excluding the inner space of the waste liquid receiving part 30a and space above the waste liquid receiving part 30a is divided into two waste liquid storage parts 29c. In other words, the waste liquid receiving part 30a is disposed to be adjacent to two waste liquid storage parts 29c with the surrounding wall 30 acting as a boundary between the two areas.

In portions, which are adjacent to the waste liquid storage part 29c, of the surrounding wall 30, slit parts 30b are formed. In an approximately center position of the inner bottom surface of the waste liquid receiving part 30a, an introduction member 31 is installed.

An absorber 32 shown in FIG. 4 is disposed inside the waste liquid storage part 29c adjacent to the maintenance unit 24. The absorber 32 has a three layer structure including an absorber 32a as a lower layer absorber, an absorber 32b as a middle layer absorber, and an absorber 32c as an upper layer absorber. As shown in FIG. 4, in the absorbers 32a, 32b, and 32c, two notch portions 32d are disposed for fitting the absorber 32 to the support plates 29b, and cutout portions 32e are formed in the absorbers 32a and 32b for forming a space inside the waste liquid receiving part 30a. Here, the cutout portion 32e is not formed in the absorber 32c disposed above the absorbers 32a and 32b. Thus, when the absorber 32c is disposed inside the reception case 29, the absorber 32c covers the waste liquid receiving part 30a. In addition, a groove 32f for containing the waste liquid tube 26 is formed in the absorber 32b.

The absorber 32a disposed on the inner bottom surface of the waste liquid storage part 29c is formed to have a width that is larger than the width of the absorbers 32b and 32c. The width of the absorber 32b having the groove 32f is formed to be slightly larger than an outer diameter of the waste liquid tube 26.

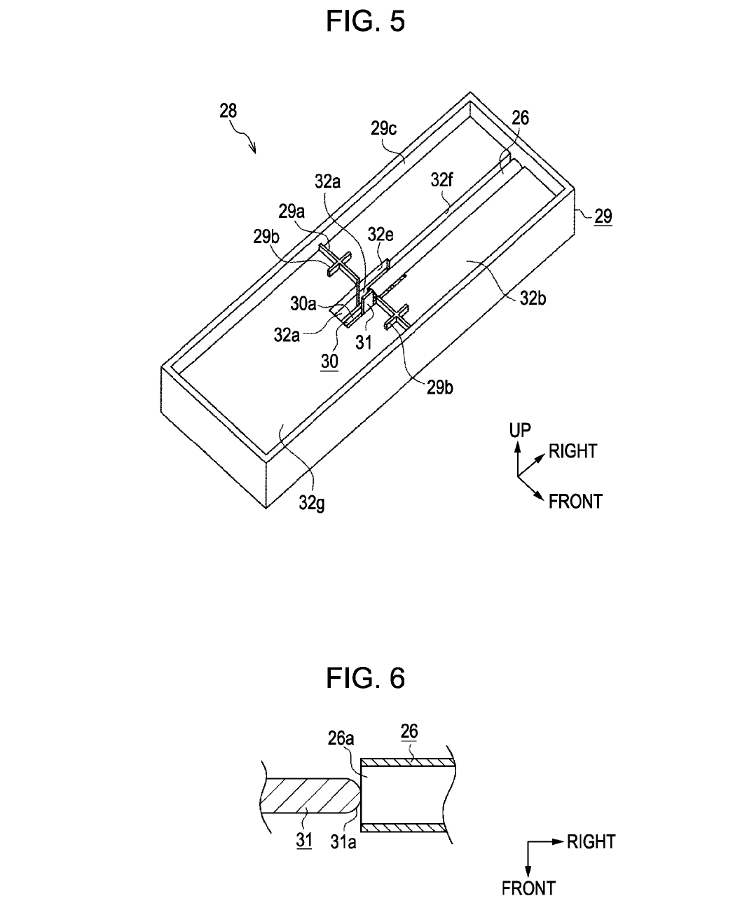

An absorber 32, similar to the three-layered absorber described above, is disposed in the waste liquid storage part 29c located on the left side in FIGS. 2 and 3. Although the shape of the absorber 32a used as a lower layer absorber and the absorber 32c used as an upper layer absorber is the same as that disposed in the right side of the waste liquid storage part 29c, the groove 32f is not formed in the middle layer absorber 32g, as shown in FIG. 5. In FIG. 5, the upper layer absorber 32a is omitted, so as to more clearly illustrate the lower layers of the absorbers 32. The absorbers 32a, 32g, and 32c are disposed inside the waste liquid storage part 29c, so as to form absorbers 32 on each side of the partition plate 29a.

As shown in FIGS. 2 and 5, a waste liquid tube 26 is inserted into the waste liquid collecting mechanism 28 through an introduction hole 29d (shown in FIGS. 2 and 3) formed on the side wall of the reception case 29 adjacent to the maintenance unit 24. The waste liquid tube 26 is inserted into the groove 32f formed in the absorber 32b. As shown in FIG. 5, a downstream end 26a of the waste liquid tube 26 inserted into the waste liquid collecting mechanism 28 and is configured to face a side 31a (see FIG. 6) of the introduction member 31.

As shown in FIG. 6, the side 31a of the introduction member 31 facing the downstream end 26a of the waste liquid tube 26 has an arc-shaped horizontal cross section. The width of the introduction member 31 is configured to be smaller than the inner diameter of the waste liquid tube 26.

Next, the operation of the waste liquid collecting mechanism 28 described above will be described.

In this embodiment, the printer 11 is manufactured in a factory, wherein an ink ejecting test is performed before the printer is shipped. During this process, waste liquid tube 26 is extracted from the waste liquid collecting mechanism 28. After the test is completed, the waste liquid tube 26 is inserted into the waste liquid collecting mechanism 28 through the introduction hole 29d, wherein the printer becomes a completed product that can be shipped. Although the inside of the waste liquid collecting mechanism 28 is covered with the absorber 32c and cannot be seen, the downstream end of the inserted waste liquid tube 26 is abutted against the introduction member 31, and thus the position of the waste liquid tube 26 can be determined without being seen. Simultaneously, the opening 26a of the waste liquid tube 26 is disposed in a position which faces the introduction member 31.

Before a printing operation is initiated in the printer 11, the carriage 14 is disposed in the home position, and the nozzle forming surface 19a of the recording head 19 is sealed by the cap 25. In this state, when the printer 11 is shipped from a factory and used for the first time, a high-powered cleaning operation having a high suction power level is performed by the suction pump 27 in order to fill the nozzles with the ink located inside the ink cartridge 20 via the ink supply passage.

After the initial filling operation is performed, an ordinary cleaning operation is performed at a low suction power level by the suction pump 27. When the ink cartridge 20 is replaced or an inferior ink ejection from the nozzle is detected, the high-powered cleaning operation having a high suction power level may also be performed.

By performing the high-powered cleaning operation, a large amount of ink is sucked out and is introduced inside the waste liquid collecting mechanism 28 through the waste liquid tube 26. When this high-powered cleaning operation is performed, the waste liquid which has been introduced inside the waste liquid collecting mechanism 28 through the waste liquid tube 26 is ejected from the opening 26a to an area above the waste liquid receiving part 30a. At this moment, the introduction member 31 is disposed in a position facing the opening 26a of the waste liquid tube 26 in order to suppress the impact of the ejected waste liquid. Then, the waste liquid is introduced into the waste liquid receiving part 30a by falling along the surface of the introduction member 31.

Although the waste liquid introduced into the waste liquid collecting mechanism 28 is stored in the waste liquid receiving part 30a with the surrounding wall 30 acting as a bank, the storage capacity of the waste liquid receiving part 30a is set to be smaller than the amount of waste liquid discharged by a single high-powered cleaning operation. Thus, when the high-powered cleaning operation is performed, the waste liquid introduced inside the waste liquid receiving part 30a overflows the surrounding wall 30 and is distributed to each waste liquid storage part 29c. At this moment, the partition plate 29a is disposed in an approximately the center of the reception case 29 and the surrounding wall 30 is disposed in approximately the center of the inner bottom of the reception case 29. Accordingly, the storage capacities of two waste liquid storage parts 29c are the approximately the same, and the lengths of portions of the surrounding wall 30 which are adjacent to each waste liquid reception part 29c are the same. Thus, the waste liquid flown over the surrounding wall 30 is almost equally distributed into the two waste liquid storage parts 29c where it is absorbed and maintained by the absorber 32. Waste liquid which has overflowed to the surrounding wall 30 is discharged from the slit parts 30b formed on the surrounding wall 30 into the adjacent waste liquid reception parts 29c.

The storage capacity of the waste liquid receiving part 30a is set to be larger than the amount of waste liquid discharged by a single ordinary cleaning operation. Thus, when a single ordinary cleaning operation is performed, the waste liquid introduced into the waste liquid receiving part 30a is discharged from the slit parts 30b into the adjacent waste liquid storage parts 29c adjacent without flowing over the surrounding wall 30. When an ordinary cleaning operation or high-powered cleaning operation are consecutively performed when the waste liquid is not discharged from the slit parts 30b and the amount of introduced waste liquid exceeds the storage capacity of the waste liquid receiving part 30a, the waste liquid overflows the surrounding wall 30 and is discharged into the waste liquid storage parts 29c.

When the recording head 19 is not sealed by the cap 25, a flushing operation for ejecting ink is regularly performed. When this flushing operation is performed, the carriage 14 is moved to a flushing position, where ink is ejected from the nozzle, replacing the ink inside the nozzle with new ink. The waste liquid discharged from the recording head 19 by the flushing operation is collected into the waste liquid collecting mechanism 28 through the through hole 21a formed on the platen 21 and is absorbed and stored by the absorber 32.

The following advantages can be acquired from the first embodiment described above.

(1) In the above-described embodiment, the waste liquid can be distributed and stored in the a plurality of waste liquid storage parts 29c having a simple configuration. The waste liquid receiving part 30a is capable of storing a predetermined amount of waste liquid and is disposed adjacent to the two waste liquid storage parts 29c with a surrounding wall 30 acting as a boundary, making it possible to suppress waste liquid from leaking.
(2) In the above-described embodiment, since the waste liquid stored in the waste liquid receiving part 30a is discharged through the slits 30b into the adjacent waste liquid storage parts 29c, it is possible to suppress thickening or solidification of the waste liquid stored in the waste liquid receiving part 30a for a long time.

### (3) In the above-described embodiment, by using the introduction member 31 installed in the inner bottom surface of the waste liquid receiving part 30a, the waste liquid can be introduced into the waste liquid receiving part 30a more reliably.

(4) In the above-described embodiment, since the waste liquid collected into the waste liquid collecting mechanism 28 is absorbed and maintained by the absorber 32, the leakage of the waste liquid outside the waste liquid storage parts 29c can be suppressed. In addition, contamination in the printer 11 due to the spread of the waste liquid in the waste liquid receiving part 30a can be suppressed by using the absorber 32a which covers the waste liquid receiving part 30a. Furthermore, even when the printer 11 is tilted or dropped, it is possible to suppress leakage of the waste liquid outside the waste liquid storage parts 29c.
(5) In the above-described embodiment, since the downstream end of the waste liquid tube 26 is opened above the waste liquid receiving part 30a, it is possible to more accurately introduce the waste liquid into the waste liquid receiving part 30a. In addition, the waste liquid tube 26 has a larger space to operate.

### (6) In the above-described embodiment, since the downstream end 26a of the waste liquid tube 26 inserted into the waste liquid collecting mechanism 28 is faces the introduction member 31, the pressure of the ejected waste liquid can be suppressed.

(7) In the above-described embodiment, since the side 31a of the introduction member 31 facing the opening 26a of the waste liquid tube 26 has an arc-shaped cross section, the ejected waste liquid which hits the introduction member 31 can be quickly diverted a side of the introduction member 31. Accordingly, the ejected waste liquid is transferred to a larger area of the introduction member 31, and therefore the waste liquid can be introduced into the waste liquid receiving part 30a in a speedy manner.
(8) In the above-described embodiment, since the width of the introduction member 31 is smaller than the inner diameter of the waste liquid tube 26, the opening 26a is closed, even when the opening 26a of the waste liquid 26 and the introduction member 31 are brought into contact with each other.
(9) In the above-described embodiment, when the waste liquid tube 26 is inserted into the waste liquid collecting mechanism 28 after an ink ejecting test is performed before shipment, the position of the waste liquid tube 26 can be determined by the introduction member 31.

### Second Embodiment

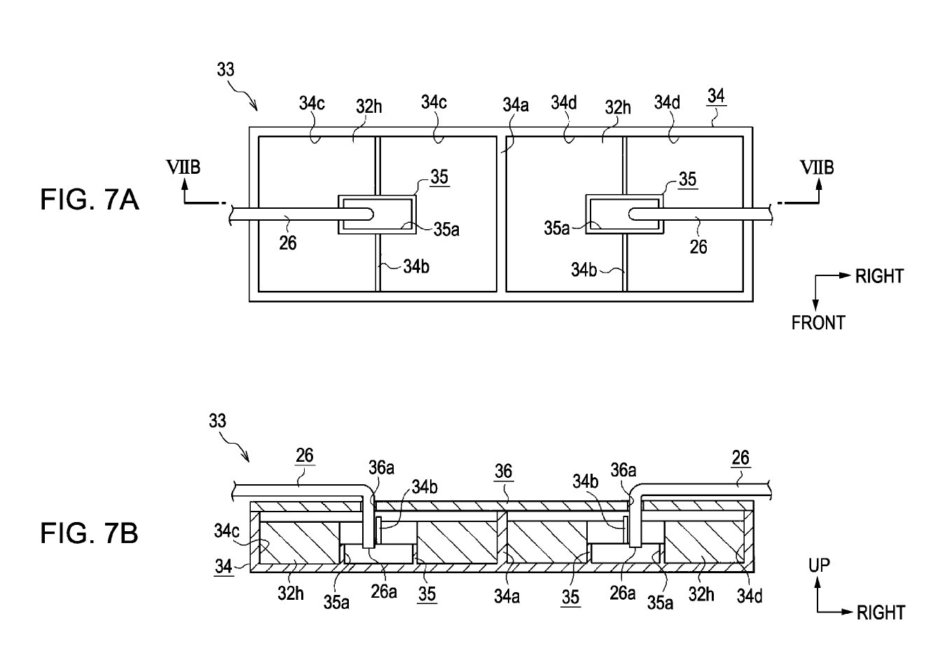

Next, a second embodiment of the present invention will be described with reference to FIGS. 7A and 7B. This embodiment, which is similar to the first embodiment described above, comprises an ink jet printer acting as a liquid ejecting device. The configuration of the waste liquid collecting mechanism, however, is different from that of the first embodiment. Hereinafter, parts that are different from those of the first embodiment will be described.

As shown in FIG. 7A, in the waste liquid collecting mechanism 33 according to this embodiment, the inside of a reception case 34 is partitioned into two spaces by a partition plate 34a disposed in an approximately the center of the reception case 34. Then, each side of the partition plate 34a is again partitioned by partition plates 34b disposed in an approximately the center of the left-hand side of the partition plate 34a, thereby forming two waste liquid storage parts 34c on the left-hand side of the partition plate 34a. Similarly, the right-hand side of the reception case 34 is partitioned into two portions by a partition plate 34b disposed in approximately the center of the left-hand side of the partition plate, thereby forming two waste liquid storage parts 34d.

In approximately center positions of inner bottom surfaces of the waste liquid storage parts 34c and 34d in the front-to rear and left-to-right directions, waste liquid receiving parts 35a formed by being surrounded by surrounding walls 35 are disposed. In other words, the waste liquid collecting mechanism 33 has waste liquid receiving parts 35a which are divided into waste liquid storage parts 34c and waste liquid storage parts 34d.

As shown in FIG. 7B, an upper opening of the reception case 34 is sealed by a lid member 36 (not shown). Introduction holes 36a are formed at positions of the lid member 36 which correspond to spaces above the waste liquid receiving parts 35a. Waste liquid tubes 26 are inserted into the waste liquid collecting mechanism 33 through these introduction holes 36a. As shown in FIG. 7B, the downstream ends 26a of the waste liquid tubes 26 inserted into the waste liquid collecting mechanism 28 drain into the waste liquid receiving parts 35a. Thus an introduction member is not disposed in this embodiment.

The other ends of the waste liquid tubes 26 inserted into the waste liquid storage parts 34c are opened toward the inner bottom surface of a collection container (not shown) disposed below the through hole 21a of the platen 21. In other words, the waste liquid storage parts 34c are configured to store the waste liquid discharged by the flushing operation. On the other hand, the upstream ends of the waste liquid tubes 26 inserted into the waste liquid storage parts 34d are opened toward the inner bottom surface of the cap 25. Thus, the waste liquid storage parts 34d are configured to store waste liquid sucked and discharged by the cleaning operation through the cap 25.

Similar to the absorber 32a of the first embodiment, absorbers 32h having cutout portions 32e are disposed in the waste liquid storage parts 34c and 34d.

Next, the operation of the above-described waste liquid collecting mechanism 33 will be described.

When the high-powered cleaning operation is performed in the printer 11, the sucked and discharged waste liquid is transferred via the waste liquid tube 26 connected to the cap 25 to the waste liquid receiving part 35a adjacent to the waste liquid storage parts 34d. Then, the remaining waste liquid that can not be stored in the waste liquid receiving part 35a flows over the surrounding wall 35, where it is distributed to the waste liquid storage parts 34d and absorbed and stored by the absorber 32h. The waste liquid not flowing over the surrounding wall 35 is stored until the high-powered or ordinary cleaning operation is performed, wherein an additional amount of waste liquid will be transferred to the liquid receiving part 35a, causing more waste liquid to flow over the surrounding wall 35.

When a flushing operation is performed in the printer 11 according to this embodiment, waste liquid discharged from the nozzle is introduced into the waste liquid receiving part 35a adjacent to the waste liquid storage parts 34c through the waste liquid tube 26 connected to the collecting container. When the flushing operation is performed numerous times and the waste liquid cannot be fully stored in the waste liquid receiving part 35a, the waste liquid overflows the surrounding wall 35, and is distributed into the waste liquid storage parts 34c, where it is absorbed and stored by the absorber 32.

According to the second embodiment described above, the following advantages can be acquired in addition to the advantages described above in reference to the first embodiment.

(10) In the above-described embodiment, since the waste liquid collected into the waste liquid collecting mechanism 33 is absorbed and maintained by the absorber 32h, it is possible to suppress leakage of the waste liquid outside the waste liquid storage parts 34c and 34d. In addition, contamination in the printer 11 due to the spreading of the waste liquid introduced into the waste liquid receiving parts 35a can be suppressed by the lid member 36 used for sealing the opening of the reception case 34. In addition, since the introduction hole 36a is disposed on an upper side relative to the absorber 32h, leakage of the waste liquid outside the waste liquid storage parts 34c and 34d can be suppressed, even when the printer 11 is tilted steeply.
(11) In the above-described embodiment, since the downstream ends of the waste liquid tubes 26 drain into the waste liquid receiving parts 35a, it is possible to more reliably introduce the waste liquid into the waste liquid receiving parts 35a. In addition, since the introduction member is not required, the configuration of the waste liquid collecting device can be simplified.
(12) In the above-described embodiment, since the waste liquid collecting mechanism 33 can be disposed in an area other than the area below the platen 21, the degree of freedom for placing the waste liquid collecting mechanism 33 thereof can be improved.

### Third Embodiment

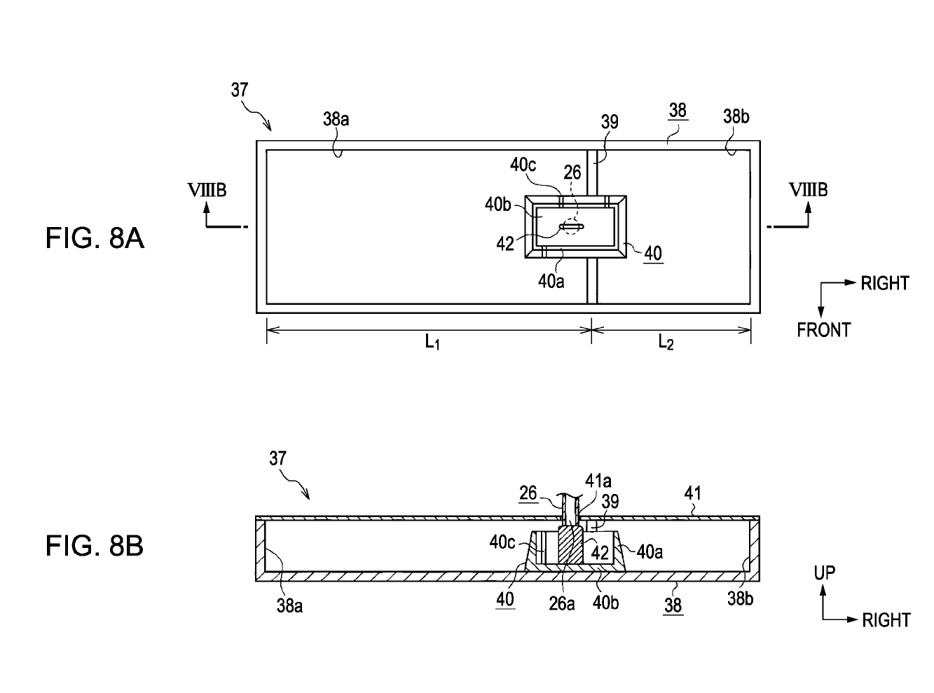

Next, a third embodiment of the present invention will be described with reference to FIGS. 8A and 8B. This embodiment, similar to the first embodiment described above, an ink jet printer is used to illustrate an example of a liquid ejecting device according to an embodiment of the invention. In this embodiment, however, the configuration of the waste liquid collecting mechanism is different from that of the first embodiment. Hereinafter, parts that are different from those of the first two embodiments will be described.

A waste liquid collecting mechanism 37 according to this embodiment has an approximately rectangular shape extending horizontally and has a reception case 38 with an open upper surface. As shown in FIG. 8A, a partition plate 39 is formed so as to divide the inside length of the reception case 38 in the ratio of L1:L2 (where L1>L2).

A waste liquid reception member 40 with a rectangular box shape is used as a waste liquid receiving part. The waste liquid reception member 40 is fixed on the inner bottom surface of the reception case 38 which intersects the partition plate 39. The waste liquid reception member 40, as shown in FIG. 8B has a surrounding wall 40a with a side wall and a bottom wall 40b.

A portion of the partition plate 39 is cut out in a position corresponding to the inside of the waste liquid receiving member 40 and area above the waste liquid receiving member 40. Inside the reception case 38, waste liquid storage parts 38a (on the left side in FIGS. 8A and 8B) and 38b (on the right side in the figures) are from, in a shape that corresponds to the inside of the reception case 38 excluding the inner space of the waste liquid receiving member 40 and a space above the waste liquid receiving member 40. In other words, the waste liquid receiving member 40 is disposed so to be adjacent to the waste liquid storage parts 38a and 38b with the surrounding wall 40a used as a boundary between the two areas.

The length of a portion of the surrounding wall 40a adjacent to the waste liquid storage part 38a, which serves as a bank, adjacent to the waste liquid storage part 38a and the length of a portion of the surrounding wall 40a, which serves as a bank, adjacent to the waste liquid storage part 38b are configured to be in the ratio of L1:L2. When the waste liquid storage capacity of the waste liquid storage part 38a is V1 and waste liquid storage capacity of the waste liquid storage part 38b is V2, the ratio of the waste liquid storage capacities is configured to be V1:V2=L1:L2.

The height difference of the surrounding wall 40a and the side wall of the reception case 38 is configured to be smaller than that in the first embodiment or the second embodiment. According to this embodiment, inside the waste liquid storage parts 38a and 38b, an absorber is not disposed.

As shown in FIG. 8A, slit parts 40c are formed in two spots adjacent to the waste liquid storage part 38a and in one spot adjacent to the waste liquid storage part 38b in the surrounding wall 40a of the waste liquid receiving member 40.

As shown in FIG. 8B, the upper opening of the reception case 38 is sealed by a film member 41 (not shown). An introduction hole 41a is formed in a position of the film member 41 corresponding to an area above the waste liquid receiving member 40. The waste liquid tube 26 is inserted into the waste liquid collecting mechanism 37 via the introduction hole 41a with the upstream end opening toward the inner bottom surface of the cap 25. As shown in FIG. 8B, the downstream end 26a of the waste liquid tube 26 inserted into the waste liquid collecting mechanism 37 is opened downward above the waste liquid receiving member 40.

An introduction member 42 is installed on the inner bottom surface of the waste liquid receiving member 40. A downstream end opening 26a of the waste liquid tube 26 is configured to face a top surface (see FIG. 6) of the introduction member 42. The top surface of the introduction member 42 facing the downstream end 26a of the waste liquid tube 26 has an arc-shaped cross section. The width of the introduction member 42 is configured to be smaller than the inner diameter of the waste liquid tube 26.

Next, the operation of the above-described waste liquid collecting mechanism 37 will be described.

The printer 11 according to this embodiment is manufactured in a factory. Before the printer 11 is shipped, an ink ejecting test is performed before the waste liquid tube 26 is added to waste liquid collecting mechanism 37. After the test is completed, the waste liquid tube 26 is inserted into the waste liquid collecting mechanism 37 through the introduction hole 41a, and then, the printer becomes a completed product that can be shipped. Although the inside of the waste liquid collecting mechanism 37 is covered with the film member 41 and cannot be seen, the downstream end of the waste liquid tube 26 is abutted to the introduction member 42, and thus the position of the waste liquid tube 26 is determined without being seen. Simultaneously, the opening 26a of the waste liquid tube 26 is disposed at a position which faces the introduction member 42.

When the high-powered cleaning operation is performed in the printer 11, the waste liquid which has been introduced inside the waste liquid collecting mechanism 37 via the waste liquid tube 26 is ejected to above the waste liquid receiving member 40. The introduction member 42 is disposed at a position which faces the opening 26a of the waste liquid tube 26, and accordingly, the pressure of the ejected waste liquid is suppressed and the waste liquid is introduced into the waste liquid receiving member 40 through the introduction member by falling along the surface of the introduction member 42.

The remaining waste liquid that can not be stored in the waste liquid receiving member 40 overflows over the surrounding wall 40a and is distributed into the waste liquid storage parts 38a and 38b in the ratio of V1:V2 (=L1:L2). On the other hand, waste liquid that does not over flow the surrounding wall 40a is discharged from the slit parts 40c formed on the surrounding wall 40a into the adjacent waste liquid storage parts 38a and 38b in the ratio of 2:1.

When the ordinary cleaning operation is performed only once, the waste liquid introduced into the waste liquid receiving member 40 is discharged from the slit parts 40c into the waste liquid storage parts 38a and 38b adjacent thereto without flowing over the surrounding wall 40a.

In the printer 11 according to this embodiment, the waste liquid discharged from the recording head 19 by the flushing operation is absorbed and maintained by an absorber (not shown) disposed additionally below the hole 21a. In other words, the waste liquid collecting mechanism 28 is configured to store only the waste liquid sucked and discharged by the cleaning operation.

According to the third embodiment described above, the following advantages can be acquired in addition to the “(1)” to “(3)”, “(6)” to “(9)”, and “(12)” advantages described above.

(13) In the above-described embodiment, contamination in the printer 11 due to the spreading of the waste liquid collected into the waste liquid collecting mechanism 37 can be prevented by the film member 41 sealing the opening of the reception case 38. In addition, since the introduction hole 41a is disposed on an upper side of the liquid collecting mechanism 37, the leakage of the waste liquid beyond the areas in the waste liquid storage parts 38a and 38b can be suppressed even when the printer 11 is tilted.

### (14) In the above-described embodiment, since the downstream end of the waste liquid tube 26 is opened above the waste liquid receiving member 40, it is possible to more reliably introduce the waste liquid into the waste liquid receiving member 40.

### (15) In the above-described embodiment, since the waste liquid receiving part 40 and the partition plate 39 are formed separately from the reception case 38, it is possible to use a general reception case 38.

(16) In the above-described embodiment, the waste liquid receiving member 40 (waste liquid storage part) is not necessarily disposed in the center position of the inner bottom surface of the reception case 38. In addition, since the waste liquid storage parts 38a and 38b and the waste liquid receiving member 40 may have any form, the surrounding wall 40a, may be set in accordance with the waste liquid storage capacity, improving the degree of freedom for designing the device
(17) In the above-described embodiment, since the number of the slit parts 40c is changed in accordance with the storage capacities of the waste liquid storage parts 38a and 38b, the waste liquid stored in the waste liquid receiving member 40 may be distributed in accordance with the storage capacities of the waste liquid storage parts 38a and 38b.

The above-described embodiments may be changed into the following different embodiments.

In the first embodiment, although the absorber 32c disposed on the inner bottom surface of the waste liquid storage part 29c is formed to be thicker than the absorbers 32b and 32c disposed on the upper side thereof, the absorber 32a may have a same depth as the absorbers 32b and 32c and a plurality of the absorbers 32a overlap each other. In addition, only one single absorber 32 in which a cutout portion 32e and the like are formed may be disposed in the waste liquid storage part.

In the above-described first and third embodiments, only one slit part may be disposed in the waste liquid receiving part.

In the above-described second embodiment, although the waste liquid generated by the flushing operation is stored in the waste liquid storage part 34c, the waste liquid sucked and discharged by the cleaning operation may also be stored in the waste liquid storage part 34c. For example, even when different types of ink are configured to be ejected from different nozzle lines, each type of ink may be individually collected and stored in the waste liquid storage parts 34c and 34d. In addition, the waste liquid storage capacities of the waste liquid storage parts 34c and 34d may be changed.

In the above-described embodiments, the number of waste liquid storage parts adjacent to one waste liquid receiving part is not limited to two, and any arbitrary number of waste liquid receiving parts, such as three or four, may be formed adjacent to one waste liquid receiving part. As described above, by increasing the number of distribution channels of the waste liquid, the level of the ink may be lowered. Furthermore, in the second embodiment, the numbers of the waste liquid storage parts 34c and 34d adjacent to one waste liquid receiving part may be changed.

In the above-described embodiments, the waste liquid storage parts do not necessarily have a rectangular box shape and may have any arbitrary shape. In addition, the plane view of the waste liquid receiving part is not limited to a rectangular shape and may be any arbitrary shape. In such a case, the lengths of the portions serving as a bank are set in accordance with the waste liquid storage capacities of the adjacent waste liquid storage parts, in order to efficiently store the waste liquid. For example, when the storage capacities of two waste liquid storage parts are V1 and V2, the lengths of the portions, which serve as a bank adjacent to each waste liquid storage part are set to be V1:V2.

In the above-described embodiments, although the storage capacity of the waste liquid receiving part is set to be smaller than the amount of waste liquid discharged by a single high-powered cleaning operation, the storage capacity may be set to any arbitrary storage capacity such as a storage capacity smaller than the amount of waste liquid discharged by a single ordinary cleaning operation.

In the above-described embodiments, although the liquid ejecting head is described in each embodiment as an ink jet printer, the invention may be applied to various types of liquid ejecting devices other than printers. For example, the invention may be applied to a printing device used for a facsimiles, copiers, or the like, in liquid crystal display devices, EL displays, plane emission displays, or the like, as well as in liquid ejecting devices capable of ejecting colored liquid material, liquid ejecting devices for ejecting living-body organic matter for manufacturing a bio-chip, or precision pipette sample ejecting devices.

What is claimed is:

1. A waste liquid collecting mechanism for collecting waste liquid discharged from the liquid ejecting head of a liquid ejecting device, the waste liquid collecting mechanism comprising:
a reception case partitioned into a plurality of waste liquid storage parts,
wherein the reception case includes a waste liquid receiving part surrounded by a surrounding wall disposed adjacent to the waste liquid storage parts, the surrounding wall acting as a boundary between the waste liquid receiving part and the waste liquid storage parts, wherein the waste liquid receiving part is capable of storing a predetermined amount of waste liquid and any waste liquid introduced into the waste liquid receiving part beyond the predetermined amount is distributed to the waste liquid storage parts by flowing over the surrounding wall.

2. The waste liquid collecting mechanism according to claim 1,
wherein a slit is formed in the surrounding wall, and the waste liquid stored in the waste liquid receiving part is distributed into the adjacent waste liquid storage parts through the slit.

3. The waste liquid collecting mechanism according to claim 1, further comprising an introduction member that is disposed on an inner bottom surface of the waste liquid receiving part, wherein the waste liquid discharged from the liquid ejecting head is distributed to the waste liquid receiving parts through the introduction member.

4. The waste liquid collecting mechanism according to claim 1, wherein each waste liquid storage part includes an absorber comprising a lower layer absorber disposed on the inner bottom surface of the waste liquid storage part and an upper layer absorber disposed on the upper portion of the waste receiving part so as to cover the waste receiving part.

5. The waste liquid collecting mechanism according to claim 1, wherein the length of a portion of the surrounding wall which is adjacent to the waste liquid storage parts, that serves as a bank corresponds to the waste liquid storage capacities of the adjacent waste liquid storage parts.

6. A liquid ejecting device comprising:
a liquid ejecting head for ejecting liquid; and
the waste liquid collecting mechanism according to claim 1 for collecting waste liquid discharged from the liquid ejecting head.

7. The liquid ejecting device according to claim 6, further comprising:
a waste liquid introducing passage for transferring the waste liquid discharged from the liquid ejecting head to the waste liquid collecting mechanism,
wherein an end of the waste liquid introducing passage drains into the waste liquid receiving part or above the waste liquid receiving part.

8. The liquid ejecting device according to claim 6, further comprising:
a waste liquid introducing passage for transferring the waste liquid discharged from the liquid ejecting head to the waste liquid collecting mechanism,
wherein an end of the waste liquid introducing passage drains horizontally into the waste liquid receiving part or above the waste liquid receiving part.

9. A liquid ejecting device comprising:
a liquid ejecting head for ejecting liquid;
a waste liquid collecting mechanism including a reception case partitioned into a plurality of waste liquid storage parts; and
a waste liquid introducing passage for transferring the waste liquid discharged from the liquid ejecting head to the waste liquid collecting mechanism, wherein the liquid introducing passage comprises a tube with one end that drains into the waste liquid receiving part or above the waste liquid receiving part;
wherein the reception case includes a waste liquid receiving part surrounded by a surrounding wall disposed adjacent to the waste liquid storage parts, the surrounding wall acting as a boundary between the waste liquid receiving part and the waste liquid storage parts, wherein the waste liquid receiving part is capable of storing a predetermined amount of waste liquid and any waste liquid introduced into the waste liquid receiving part beyond the predetermined amount is distributed to the waste liquid storage parts by flowing over the surrounding wall.

10. The liquid ejecting device according to claim 9,
wherein a slit is formed in the surrounding wall, and the waste liquid stored in the waste liquid receiving part is distributed into the adjacent waste liquid storage parts through the slit.

11. The liquid ejecting device according to claim 9, further comprising an introduction member that is disposed on an inner bottom surface of the waste liquid receiving part, wherein the waste liquid discharged from the liquid ejecting head is distributed to the waste liquid receiving parts through the introduction member.

12. The liquid ejecting device according to claim 9, wherein each waste liquid storage part includes an absorber comprising a lower layer absorber disposed on the inner bottom surface of the waste liquid storage part and an upper layer absorber disposed on the upper portion of the waste receiving part so as to cover the waste receiving part.

13. The liquid ejecting device according to claim 9, wherein the length of a portion of the surrounding wall which is adjacent to the waste liquid storage parts, that serves as a bank corresponds to the waste liquid storage capacities of the adjacent waste liquid storage parts.

14. The liquid ejecting device according to claim 9, further comprising:
a waste liquid introducing passage for transferring the waste liquid discharged from the liquid ejecting head to the waste liquid collecting mechanism,
wherein an end of the waste liquid introducing passage drains horizontally into the waste liquid receiving part or above the waste liquid receiving part.
